(19) United States
(12) Patent Application Publication
(10) Pub. No.: US 2017/0070671 A1
(43) Pub. Date: Mar. 9, 2017

(54) SYSTEMS, METHODS, APPARATUSES, AND NON-TRANSITORY COMPUTER READABLE MEDIA FOR AUTOMATICALLY TUNING OPERATION PARAMETERS OF IMAGE SIGNAL PROCESSORS

(71) Applicant: Samsung Electronics Co., Ltd., Suwon-si (KR)

(72) Inventor: Ju Hyun Cho, Suwon-si (KR)

(73) Assignee: Samsung Electronics Co., Ltd., Suwon-si (KR)

(21) Appl. No.: 15/257,190

(22) Filed: Sep. 6, 2016

(30) Foreign Application Priority Data
Sep. 7, 2015 (KR) 10-2015-0126187

(51) Int. Cl. H04N 5/232

(52) U.S. Cl. CPC H04N 5/23229; H04N 5/23216

(57) ABSTRACT

A method of automatically tuning operation parameters of an image signal processor which processes a raw image in a data processing system including a processor is provided. The method includes the processor receiving the raw image and metadata involved in generation of the raw image, automatically tuning a first representative value of a first parameter sets related to first parameters using the raw image, the metadata, and either of a specification and a reference image, automatically tuning the first parameters based on the tuned first representative value, and transmitting the first parameters to the image signal processor.

### CROSS-REFERENCE TO RELATED APPLICATION

This application claims priority under 35 U.S.C. §119(a) from Korean Patent Application No. 10-2015-0126187 filed on Sep. 7, 2015, in the Korean Intellectual Property Office (MPG), the disclosure of which is hereby incorporated by reference in its entirety.

### BACKGROUND

Various example embodiments of the inventive concepts relate to auto-tuning systems, methods, apparatuses, and/or non-transitory computer readable media. More particularly, at least one example embodiment is directed to systems, methods, apparatuses, and/or non-transitory computer readable media for automatically tuning the operation parameters of an image signal processor, the operation parameters being related with objective and/or subjective image quality evaluation.

One of the main tasks of camera systems is to provide images of a good image quality. A camera system usually processes a raw image, generated by an image sensor included in the camera system, using an image signal processor included in the camera system which then displays the resultant processed image on a display.

An image signal processor includes at least one pipeline including a plurality of image processing blocks. Several thousand parameters are used in the image processing blocks. Conventionally, engineers analyze the characteristics of each of the thousands of parameters and adjust these parameters according to the analysis result in order to provide image quality that may satisfy users. Such procedures require a lot of man-time, resources, and expense. Moreover, whenever camera components and/or modules, such as lenses, sensors, and actuators are changed, engineers need to newly and/or re-analyze and adjust the parameters in view of the changed components and modules.

### SUMMARY

According to some example embodiments of the inventive concepts, there is provided a method of automatically tuning at least one operation parameter of at least one image signal processor configured to process a raw image in a data processing system including at least one processor. The method includes receiving, by the at least one processor, the raw image, which will be processed by the at least one image signal processor, and metadata related to generation of the raw image, automatically tuning, by the at least one processor, a first representative value of a first parameter net using the raw image, the metadata, and at least one of a specification and a reference image, the first parameter set including a plurality of parameters grouped according to an operation parameter, automatically tuning, by the at least one processor, each of the plurality of parameters of the first parameter set based on the first representative value that has been tuned, and transmitting, by the at least one processor, the plurality of parameters of the first parameter set that have been tuned to the at least one image signal processor.

The method may further include selectively executing, by the at least one processor, the first parameter set among a plurality of parameter sets based on a user input.

The receiving the raw image and the metadata may include receiving the raw image and the metadata from a device being tested, the data processing system including the at least one image signal processor.

The automatically tuning each of the plurality of parameters of the first parameter set may include automatically tuning each of the plurality of parameters using a mapping table which maps the first representative value to each of the plurality of parameters of the first parameter set.

The plurality of parameters of the first parameter set may include at least one parameter related to at least one of: bad pixel correction, noise reduction, lens shading correction, color correction, gamma correction, sharpness enhancement, auto exposure correction, auto focus correction, and auto white balance.

The at least one image signal processor may be an image signal processor modeled by a circuit simulator, and the at least one processor may be configured to execute the modeled image signal processor.

The modeled image signal processor may be configured to set the tuned plurality of parameters in a register of the modeled image signal processor, generate a tuned image by processing the raw image using the plurality of parameters set in the register, and output the tuned image.

According to other example embodiments of the inventive concepts, there is provided a method of automatically tuning operation parameters of at least one image processor which processes a raw image in an auto-tuning system, the auto-tuning system including a data processing system, the data processing system including at least one processor and at least one device under test (DUT), the DUT including the at least one image signal processor. The method includes capturing, using an image sensor included in the DUT, an image, generating, using the image sensor, the raw image related to the captured image, generating, using the image signal processor, metadata involved in the generation of the raw image, automatically tuning, by the at least one processor, a first representative value of a first parameter set related to a plurality of parameters grouped in the first parameter set using the raw image, the metadata, and at least one of a specification and a reference image, the first parameter set related to an operation parameter, automatically tuning, by the at least one processor, the plurality of parameters of the first parameter set based on the first representative value that has been tuned, and transmitting, by the at least one processor, the plurality of parameters that have been tuned to the DUT.

The method may further include receiving, by the at least one image signal processor, the plurality of parameters that have been tuned, storing, by the at least one image signal processor, the plurality of parameters that have been received in a register of the at least one image signal processor, reading, by the at least one image signal processor, the raw image from a memory included in the DUT, generating, by the at least one image signal processor, a tuned image by processing the raw image output from the memory using the stored plurality of parameters, and outputting, by the at least one image signal processor, the tuned image.

When the auto-tuning system further includes a test system, the method may further include determining, by a test system, whether the tuned image output from the image signal processor satisfies a second plurality of parameters which are included in the specification and correspond to the plurality of parameters, and outputting, by the test system, a determination result based on the determining.

The plurality of parameters may be related to at least one of: bad pixel correction, noise reduction, lens shading correction, color correction, gamma correction, sharpness enhancement, auto exposure correction, auto focus correction, and auto white balance.

The method may further include selectively executing, by the at least one processor, the first parameter set among a plurality of parameter sets based on a user input.

The automatically tuning the plurality of parameters may include automatically tuning the first parameters using a mapping table which maps the first representative value to the plurality of parameters.

According to other example embodiments of the inventive concepts, there is provided a method of tuning operation parameters for at least one image signal processor. The method includes loading, by at least one processor, an image signal processor model into a memory, tuning, by the at least one processor, at least one operation parameter associated with the loaded image signal processor using at least a raw image and metadata related to the raw image, storing, by the at least one processor, the tuned at least one operation parameter into the memory, processing, by the at least one processor, the raw image using the image signal processor model in accordance with the tuned at least one operation parameter, and outputting, by the at least one processor, the processed image to an external device for testing.

The tuning may further include tuning the at least one operation parameter using an image specification or a reference image.

The at least one operation parameter may be a parameter associated with bad pixel correction, noise reduction, lens shading correction, color correction, gamma correction, sharpness enhancement, auto exposure correction, auto focus correction, and auto white balance.

The image signal processor model may include at least one image signal processing pipeline, the pipeline including a plurality of image processing blocks.

The at least one operation parameter may include a plurality of operation parameters, the plurality of operation parameters grouped into at least a dynamic operation parameter group and a static dynamic group.

The dynamic operation parameter group may include operation parameters that exert a direct influence on an output of the image processing blocks, and the static operation parameter group may include the operation parameters of the plurality of operation parameters not included in the dynamic operation parameter group.

The tuning may further include receiving at least one parameter value associated with the at least one operation parameter, receiving a selection signal indicating an operation parameter set to be tuned, and tuning the selected operation parameter set using the received at least one parameter value.

### BRIEF DESCRIPTION OF THE DRAWINGS

The foregoing and other features of inventive concepts will be apparent from the more particular description of non-limiting example embodiments of inventive concepts, as illustrated in the accompanying drawings in which like reference characters refer to like parts throughout the different views. The drawings are not necessarily to scale, emphasis instead being placed upon illustrating principles of inventive concepts. In the drawings:

FIG. 1 is a block diagram of an auto-tuning system for automatically tuning operation parameters of an image signal processor according to some example embodiments of the inventive concepts;

FIG. 2 is a conceptual diagram of the grouping of operation parameters of an image signal processor according to some example embodiments of the inventive concepts;

FIG. 3 is a block diagram illustrating the operation of an auto-tuning program executed in a data processing system illustrated in FIG. 1, according to some example embodiments of the inventive concepts;

FIG. 4 is a graph showing the results of behavior modeling of a first parameter set illustrated in FIG. 2, according to some example embodiments of the inventive concepts;

FIG. 5 is a table of mapping representative values of the first parameter set illustrated in FIG. 2 to parameters, according to some example embodiments of the inventive concepts;

FIG. 6 is a flowchart of a method of automatically tuning operation parameters of an image signal processor according to some example embodiments of the inventive concepts;

FIG. 7 is a block diagram of an auto-tuning system for automatically tuning operation parameters of an image signal processor according to some example embodiments of the inventive concepts;

FIG. 8 is a block diagram illustrating the operation of an auto-tuning program executed in a data processing system illustrated in FIG. 7 and the operation of a modeled image signal processor, according to some example embodiments of the inventive concepts; and

FIG. 9 is a flowchart of a method of automatically tuning operation parameters of an image signal processor according to some example embodiments of the inventive concepts.

### DETAILED DESCRIPTION

Various example embodiments will now be described more fully with reference to the accompanying drawings, in which some example embodiments are shown. Example embodiments, may, however, be embodied in many different forms and should not be construed as being limited to the embodiments set forth herein; rather, these example embodiments are provided an that this disclosure will be thorough and complete, and will fully convey the scope of example embodiments of inventive concepts to those of ordinary skill in the art. In the drawings, the thicknesses of layers and regions are exaggerated for clarity. Like reference characters and/or numerals in the drawings denote like elements, and thus their description may be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present, Other words used to describe the relationship between elements or layers should be interpreted in a like fashion (e.g., “between” versus “directly between,” “adjacent” versus “directly adjacent,” “on” versus “directly on”). As used herein the term “and/or” includes any and all combinations of one or more of the associated listed items.

It will be understood that although the terms “first”, “second”, etc. may be used herein to describe various elements, components, regions, layers and/or sections. These elements, components, regions, layers and/or sections should not be limited by these terms, These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof Expressions such as “at least one of,” when preceding a list of elements, modify the entire list of elements and do not modify the individual elements of the list.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Although corresponding plan views and/or perspective views of some cross-sectional view(s) may not be shown, the cross-sectional view(s) of device structures illustrated herein provide support for a plurality of device structures that extend along two different directions as would be illustrated in a plan view, and/or in three different directions as would be illustrated in a perspective view. The two different directions may or may not be orthogonal to each other. The three different directions may include a third direction that may be orthogonal to the two different directions. The plurality of device structures may be integrated in a same electronic device. For example, when a device structure (e.g., a memory cell structure or a transistor structure) is illustrated in a cross-sectional view, an electronic device may include a plurality of the device structures (e.g., memory cell structures or transistor structures), as would be illustrated by a plan view of the electronic device. The plurality of device structures may be arranged in an array and/or in a two-dimensional pattern.

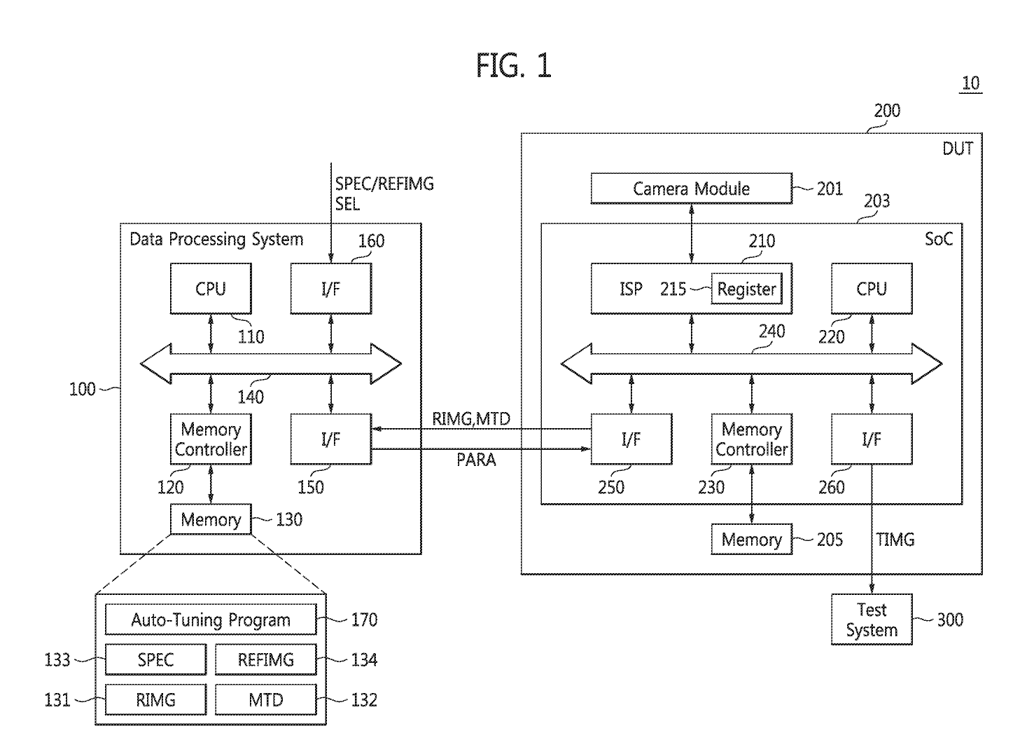

FIG. 1 is a block diagram of an auto-tuning system 10 for automatically tuning operation parameters of an image signal processor (ISP) 210 according to some example embodiments of the inventive concepts. The auto-tuning system 10 may include a data processing system 100 and a device under test (DUI) 200 which are connected and communicate at least one command and/or data to each other. In other words, the various components of the data processing system 100 are configured to engage in bi-directional communication with each other component of the data processing system 100. The auto-tuning system 10 may also include a test system 300.

The data processing system 100 may adjust one or more operation parameters based on a specification (e.g., image specification) and/or reference image related to objective and/or subjective image quality evaluation and may provide adjusted operation parameters for the DUT 200. The adjusted operation parameters may be programmed or set in a register 215 of the ISP 210.

The data processing system 100 may be a tester or a test system. In other words, the data processing system 100 may refer to a system which tests a device such as DUT, equipment under test (EUT), and/or unit under test (UUT). The data processing system 100 may he an automatic or automated test equipment (ATE).

The data processing system 100 may be implemented as a personal computer, a workstation, a distributed computing system, a mobile computing device, a smart device, a wearable device, a gaming console, an Internet of Things (IoT) device, etc., but the inventive concepts are not restricted to these examples. The data processing system 100 may include at least one central processing unit (110), a memory controller 120, a memory 130, a bus architecture 140, a first interface (I/F) 150, and a second I/F 160, etc., but is not limited thereto and the data processing system 100 may include more or less components.

The CPU 110 may be a processor including at least one processing core. The CPU 110 may be configured to communicate a command and/or data with the memory controller 120, the first I/F 150, and the second FF 160 through the bus architecture 140. When the data processing system 100 is booted, data and/or programs stored in the memory 130 may be loaded to cache memory in accordance with the control instructions of the CPU 110 and/or the memory controller 120, thereby transforming the CPU 110 and/or memory controller 120 into a special purpose processor. The CPU 110 is then configured to execute the data and/or programs loaded to the cache memory.

For instance, the CPU 110 may load an auto-tuning program 170 for tuning (and/or automatically tuning) operation parameters of the ISP 210 from the memory 120 to the cache memory and execute the auto-tuning program 170. The CPU 110 may tune the operation parameters of the ISP 210 using a raw image RIMG, metadata MU), etc., and/or a specification SPEC, a reference image REFIMG, etc., which are stored in the memory 130.

The memory controller 120 may store the raw image RIMG and the metadata MTD, which are output from the DUT 200, in the memory 130 in accordance with control instructions from the CPU 110. The memory controller 120 may write the data RIMG and/or MTD to, or read the data RIMG and/or MTD from, the memory 130 in accordance with control instructions from the CPU 110.

The memory 130 may be formed of volatile memory and/or non-volatile memory. The volatile memory may be random access memory (RAM), dynamic RAM (DRAM), static RAM (SRAM), L1 cache memory, L2 cache memory, etc. The non-volatile memory may be electrically erasable programmable read-only memory (EEPROM), flash memory, magnetic RAM (MRAM), spin-transfer torque MRAM, ferroelectric RAM (FeRAM), phase-change RAM (PRAM), resistive RAM, a three-dimensional (3D) memory array, etc. The memory 130 may be implemented as a hard disk drive (HDD), an optical disk drive (ODD), a smart card, a secure digital (SD) card, a multimedia card (MMC), an embedded MMC (eMMC), an embedded multi-chip package (eMCP), a perfect page NAND (PPN), a universal flash storage (UFS), a solid state drive (SSD), an embedded SSD (eSSD), etc. The memory 130 may also be implemented as a network storage device, communicable over a network interface, such as a cloud storage network, distributed computing network, etc.

Although one memory controller 120 and one memory 130 are illustrated in FIG. 1, the example embodiments are not limited therein, and the memory controller 120 may collectively represent a plurality of memory controllers and/or the memory 130 may collectively represent a plurality of memories. Accordingly, when the data processing system 100 is booted, the auto-tuning program 170 may be loaded from the non-volatile memory to the volatile memory (e.g., DRAM used as a main memory), etc.

The bus architecture 140 may be implemented as an advanced microcontroller bus architecture (AMBA), advanced high-performance bus (AHB), advanced peripheral bus (APB), advanced extensible interface (AXI), advanced system bus (ASB), or a combination thereof, but the inventive concepts are not restricted to these examples.

The first I/F 150 may communicate data (or a signal) with the DUT 200 in accordance with the control instructions of the CPU 110. For instance, the first I/F 150 may receive the raw image RIMG and the metadata MTD involved in the generation of the raw image RIMG from the DUT 200 and may transmit operation parameters PARA, which have been automatically adjusted and/or set by the auto-tuning program 170 and which are involved in the operations of the ISP 210, to the DUT 200. The first I/F 150 may be implemented to be compatible with the universal serial bus (USB) interface, but the example embodiments are not limited thereto and may be implemented using other bus interfaces, such as Peripheral Component Interconnect Express (PCIe), Serial Advanced Technology Attachment (SATA), HyperTransport, SAS (serial attached small computer system interface (SCSI)) protocol, etc.

The second I/F 160 may communicate data (or a signal) with a user input unit (not shown) or an external device (not shown) in accordance with the control instructions of the CPU 110. For instance, the second I/F 160 may receive a selection signal SEL involved in the execution of the auto-tuning program 170 from the user input unit and may receive the specification SPEC and/or the reference image REFIMG from the external device.

The first I/F 150 and the second UP 160 each may be implemented as an interface for supporting, for example, a PCIe protocol, a SATA protocol, a SAS protocol, a USB protocol, etc., but the inventive concepts is not restricted to these examples.

The DUT 200 may process a raw image captured by a camera module 201 using operation parameters provided by the data processing system 100, may generate a tuned image according to the processing result, and may output the tuned image to the test system 300. The DUT 200 may be a development board, form factor, testing device, etc., used to test the performance (e.g., objective/subjective image quality) of the ISP 210 included in a system-on-chip (SoC) 203. The DUT 200 may include the camera module 201, a controller 203, a memory 205, etc., but is not limited thereto.

The camera module 201 may include an image sensor including a pixel array, a lens, an actuator, etc. The image sensor may be, for example, an image sensor chip, a complementary metal-oxide semiconductor (CMOS) image sensor chip, a charge-couple device (CCD) image sensor chip, etc. The image sensor may process pixel signals output from pixels included in the pixel array and may generate a raw image according to the processing result. The lens may focus incident light on the pixel array. The lens may be an optical lens. The lens may move (e.g., adjust focus) in response to a control signal output from the actuator. The actuator may generate the control signal for changing the position of the lens in response to lens position information output from an auto-focus engine.

The controller 203 may be implemented as an integrated circuit (IC), a SoC, a processor, an application processor (AP), a mobile AP, a chipset, a group of chips, etc., but is not limited thereto. The controller 203 may include the ISP 210, a CPU 220, a memory controller 230, a bus architecture 240, a third I/F 250, and a fourth I/F 260, etc.

The ISP 210 may include at least one pipeline including a plurality of image processing blocks (e.g., reusable image processing semiconductor chip layout cells or designs, image processing IP cores, etc.). The ISP 210 may process the raw image captured by the camera module 201 using the parameters PARA provided from the data processing system 100 to generate a tuned image TIMG. For instance, when generating the tuned image TIMG, the ISP 210 may fetch the raw image RIMG from the memory 205, may process the raw image RIMG using the parameters PARA received from the data processing system 100, and may generate the tuned image TIMG based on the processed raw image and the received parameters PARA. At this time, the ISP 210 may read the raw image RIMG from the memory 205 using a bus transfer protocol, such as direct memory access (DMA), etc.

While passing through the one or more pipelines of the ISP 210, the raw image RIMG venerated b the camera module 201 may be processed by image processing blocks (included in the pipelines n order to convert the raw image RIMG into the tuned image TIMG. Each of the image processing blocks may perform various processing, such as had pixel correction, noise reduction, lens shading correction, color correction, gamma correction, sharpness enhancement, auto exposure correction, auto focus correction, auto white balance, etc., using various received operation parameters.

The ISP 210 may use the operation parameters PARA that have been adjusted by the data processing system 100 in order to process the raw image RIMG which has been generated by the camera module 201 and stored in the memory 205. The operation parameters PARA transmitted from the data processing system 100 may be stored in memory, such as a register 215 included in the ISP 210, etc. For instance, the CPU 220 may store the operation parameters PARA in the register 215.

The ISP 210 may generate the metadata MTD involved in the generation of the raw image RIMG in the camera module 201. For instance, the metadata MTD may include various image processing settings, such as exposure time, analog gain, aperture, focal distance, white balance gain, correlated color temperature, and/or auto exposure, etc.

The CPU 220 may control the memory controller 230, the third I/F 250, and the fourth I/F 260 through the bus architecture 240.

The memory controller 230 may control an access to the memory 205 in accordance with the control instructions of the CPU 220. The access operation may include a write operation for writing data to the memory 205 and a read operation for reading data from the memory 205. The memory controller 230 may function as a DMA controller, but is not limited thereto. For instance, the memory controller 230 may write the raw image RIMG generated by the camera module 201 to the memory 205 and may also read and transmit the raw image RIMG from the memory 205 to the ISP 210 when the raw image RIMG is processed by the ISP 210. The bus architecture 240 may be the same as or similar to the bus architecture 140, but is not limited thereto.

The third I/F 250 may communicate data (or a signal) with the data processing system 100 in accordance with the control instructions of the CPU 220. For instance, the third I/F 250 may receive the operation parameters PARA of the ISP 210 from the data processing system 100 and may transmit the raw image RIMG generated by the camera module 201 and the metadata MTD generated by the ISP 210 to the data processing system 100. The ISP 210 may generate control signals for controlling the operation of the camera module 201.

The fourth PF 260 may transmit the tuned image TIMG generated by the ISP 210 to the test system 300 in accordance with the control instructions of the CPU 220.

The third I/F 250 and the fourth I/F 260 each may be implemented as an interface for supporting for example the PCIe protocol, the SATA protocol, the SAS protocol, etc., but the inventive concepts is not restricted to these examples.

Like the memory 130, the memory 205 may be formed of volatile memory and/or non-volatile memory, including three dimensional (3D) memory arrays.

The test system 300 may receive the tuned image TIMG from the DUT 200 and may evaluate the tuned image TIMG based on the specification SPEC. For instance, the test system 300 may determine whether the tuned image TIMG satisfies conditions (e.g., parameters) defined in the specification SPEC and may output the determination result.

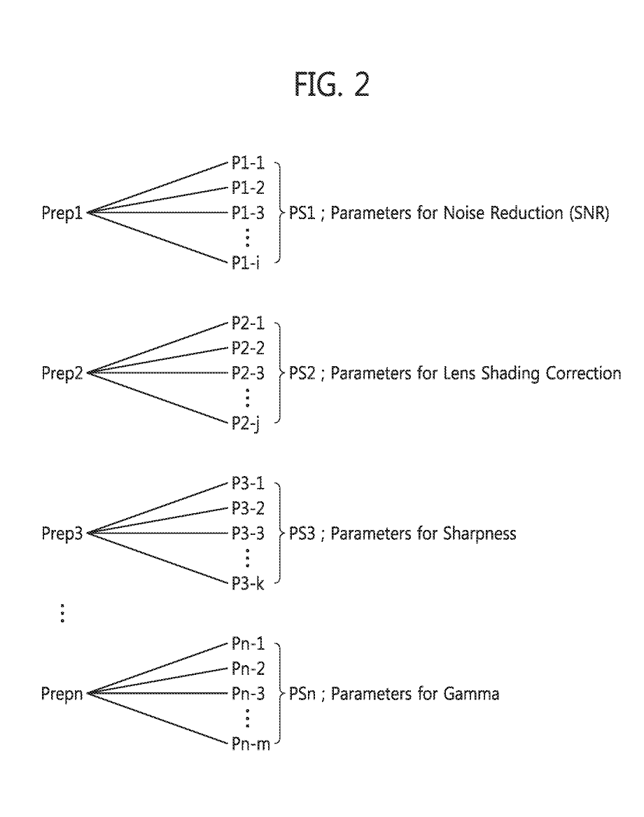

FIG. 2 is a conceptual diagram of the grouping of operation parameters of an ISP according to some example embodiments of the inventive concepts. Referring to FIGS. 1 and 2, the register 215 of the ISP 210 may store the operation parameters PARA used to process the raw image RIMG. There may he thousands of operation parameters PARA. The operation parameters PARA may be used by at least one of the image processing blocks of the ISP 210 to process the raw image RIMG.

The operation parameters PARA used in the image processing blocks may be divided into at least two groups, dynamic parameters and static parameters. The dynamic parameters may be parameters that exert a direct and critical influence on an output of each of the image processing blocks among the operation parameters PARA. The static parameters may be the rest of the operation parameters PARA excluding the parameters that are in the dynamic parameters group. In other words, the dynamic parameters may refer to parameters which need to be tuned to satisfy the conditions defined in the specification SPEC and/or the reference image REFIMG, and the static parameters may refer to parameters which have fixed values regardless of the specification SPEC and/or the reference image REFIMG.

The operation parameters PARA may be grouped into parameter sets PS1 through PSn, where “n” is a natural number of at least 4. Each of the parameter sets PS1 through PSn may be a group of parameters for processing a particular image (e.g., the raw image RIMG). For example, the first parameter set PS1 may include first parameters P1-1 through P1-i involved in noise reduction, where “i” is a natural number of at least 4. The second parameter set PS2 may include second parameters P2-1 through P2-j involved in lens shading correction, where “j” is a natural number of at least 4. The third parameter set PS3 may include third parameters P3-1 through P3-k involved in sharpness enhancement, where “k” is a natural number of at least 4. The n-th parameter set PSn may include n-th parameters Pn-1 through Pn-m involved in gamma correction, where “m” is a natural number of at least 4. Here, “i”, “j”, “k”, and “m” may be values the same as or different from one another. Additionally, while the noise reduction, lens shading correction, sharpness enhancement, and gamma correction parameter sets described in this example, the example embodiments are not limited thereto and may include any type of image processing parameters, such as had pixel correction, color correction, auto exposure correction, auto focus correction, auto white balance, etc.

The parameter sets PS1 through PSn may be represented by representative values Prep1 through Prepn, respectively. Each of the representative values Prep1 through Prepn may include a plurality of bits, which may express a certain value. When the representative values Prep1 through Prepn change, parameters related with the representative values Prep1 through Prepn may also change. For instance, when the first representative value Prep1 includes eight bits, the first representative value Prep1 may have a value of 0 to 255. When the first representative value Prep1 changes from 0 up to 255, the first parameters P1-1 through P1-i related to the first representative value Prep1 may change along with the first representative value Prep1. In other words, the parameter sets PS1 through PSn may change in accordance with changes in the associated representative values Prep1 through Prepn values as represented by the bit value of each Prep value.

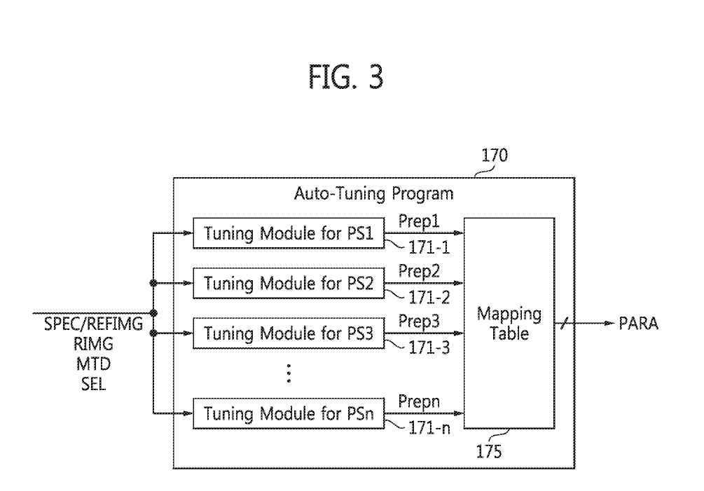

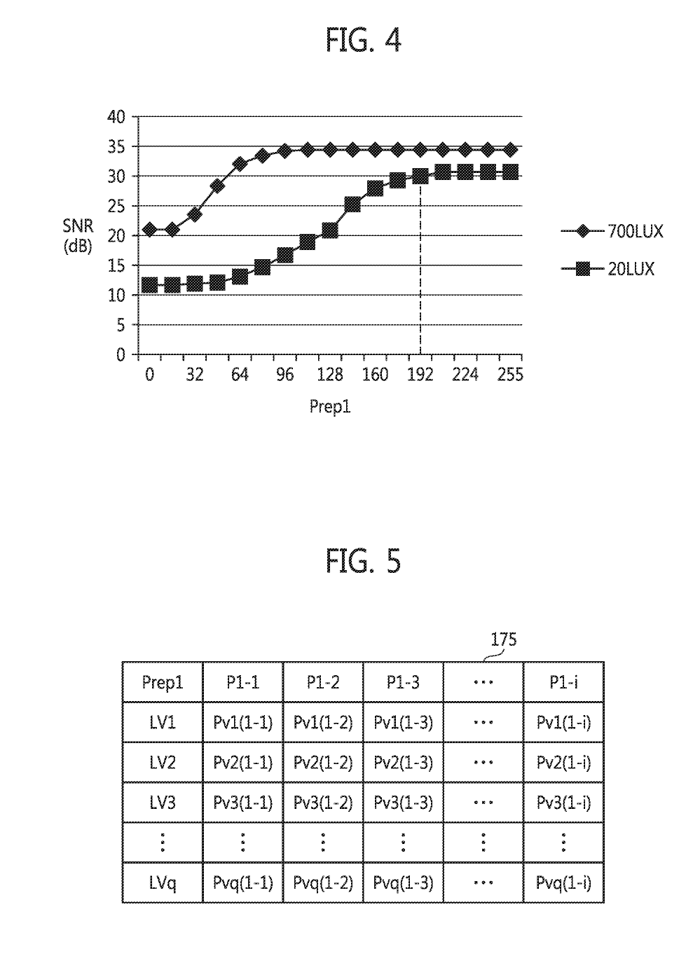

FIG. 3 is a block diagram for explaining the operation of the auto-tuning program 170 executed in the data processing system 100 illustrated in FIG. 1, according to at least one example embodiment. FIG. 4 is a graph showing the result of behavior modeling of the first parameter set PS1 illustrated in FIG. 2, according to at least one example embodiment. FIG. 5 is a diagram of a mapping table 175 for mapping representative values of the first parameter set PS1 illustrated in FIG. 2 to parameters, according to at least one example embodiment,

Referring to FIGS. 1 through 5, the auto-tuning program 170 may be loaded from the memory 130 to a cache memory (e.g., a command cache, etc.) in accordance with the control instructions of the CPU 110 and may be executed by the CPU 110. The auto-tuning program 170 may tune, or automatically tune, the operation parameters PARA, which will be used in the ISP 210, using at least one of the specification SPEC and the reference image REFIMG, the raw image RIMG, and/or the metadata MID, which are output from the memory 120.

The auto-tuning program 170 may use the reference image REFIMG for a subjective image quality test, and may use the specification SPEC and/or the reference image REFIMG, for an objective image quality test. The subjective image quality test and/or the objective image quality test may be performed by the auto-tuning program 170 according to a user's choice.

The specification SPEC and/or the reference image REFIMG may include conditions required by a user regarding the image quality of the raw image RIMG, for example, conditions related to signal-to-noise ratio (SNR), lens shading, sharpness, and gamma (pr gamma curve), etc. The specification SPEC is about the ISP 210 and may include values related to the parameters illustrated in FIG. 2, according to at least one example embodiment.

The auto-tuning program 170 may include a plurality of tuning modules 171-1 through 171-n to tune and/or adjust a representative value of one or more of the parameter sets PS1 through PSn. For instance, the first tuning module 171-1 may tune the first representative value Prep1 of the first parameter set PS1 involved in the SNR. The second tuning module 171-2 may tune the second representative value Prep2 of the second parameter set PS2 involved in the lens shading correction. The third tuning module 171-3 may tune the third representative value Prep3 of the third parameter set PS3 involved in the sharpness (or sharpness enhancement). The n-th tuning module 171-n may time the n-th representative value Prepn of the n-th parameter set PSn involved in gamma (or gamma curve). Although the tuning modules 171-1 through 171-n, as illustrated in the example embodiment of FIG. 3, are described in connection with SNR, lens shading correction, sharpness (or sharpness enhancement), and gamma (or gamma curve) parameters, the tuning modules included in the auto-tuning program 170 are not restricted to the current example embodiment and may involve other parameters including bad pixel correction, color correction, auto exposure correction, auto focus correction, auto white balance, etc.

According to some example embodiments, the tuning modules 171-1 through 171-n may tune the representative values Prep1 through Prepn, respectively, using a behavior modeling result. Behavior modeling is a process performed by adjusting the value of at least one of the parameters included in the parameter sets PS1 through PSn using the raw image RIMG and/or the metadata MTD. The behavior modeling result may be stored in the memory 130, according to at least one example embodiment, but is not limited thereto.

For instance, with reference to the example embodiment illustrated in FIG. 4, the specification SPEC may define and/or provide that the SNR of an image shot under 20 lux of light is 30 dB. As shown in FIG. 4, the first tuning module 171-1 may tune the first representative value Prep1 to “192” using the behavior modeling result for the first parameter set PS1 illustrated in FIG. 4.

The auto-tuning program 170 may tune the value of one or more of the parameters included in each of the parameter sets PS1 through PSn using one or more of the representative values Prep1 through Prepn output from the respective tuning modules 171-1 through 171-n and the mapping table 175. Referring to FIG. 5, when the first representative value Prep1 is determined to be a third value LV3, the first parameters P1-1 through P1-i may be determined to be values Pv3(1-1) through Pv3(1-n) mapped to the third value LV3 according to at least one example embodiment. When the first representative value Prep1 is determined to be a second value LV2, the first parameters P1-1 through P1-i may be determined to be values Pv2(1-1) through Pv2(1-n) mapped to the second value LV2 according to the example embodiment of FIG. 5.

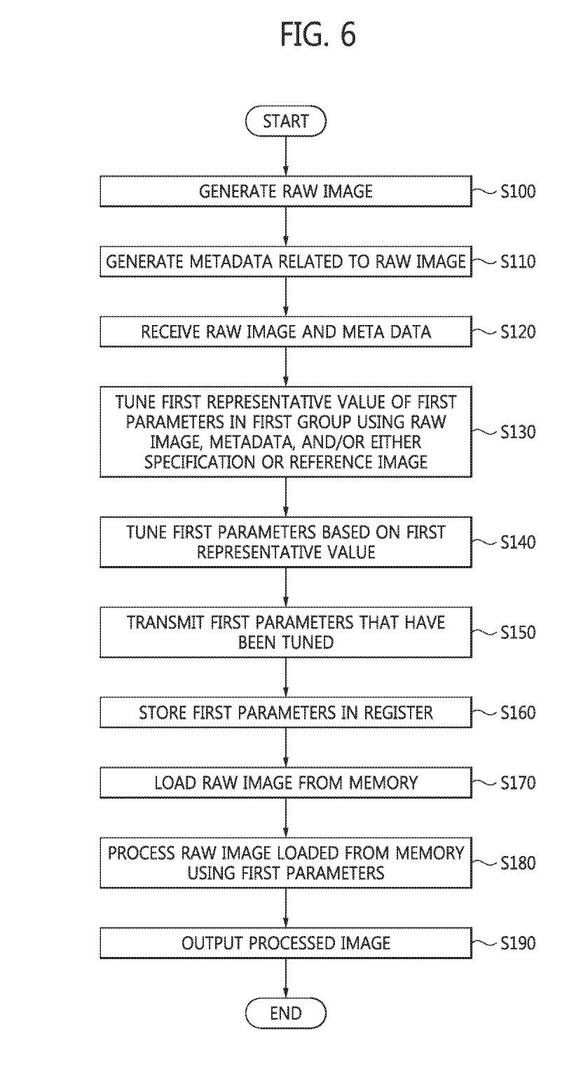

FIG. 6 is a flowchart of a method of automatically tuning the operation parameters PARA of the ISP 210 according to some example embodiments of the inventive concepts. Referring to FIGS. 1 through 6, the camera module 201 of the DUT 200 may generate the raw image RIMG from an object in operation S100.

The ISP 210 may receive the raw image RIMG and generate the metadata MTD involved in the generation of the raw image RIMG in operation S110. The metadata MTD may include information and/or data about the exposure time, analog gain, aperture, focal distance, white balance gain, correlated color temperature, and/or auto exposure parameters of the raw image RIMG. Before the raw image RIMG is processed by the ISP 210, the memory controller 230 may temporarily store the raw image RIMG in the memory 204 in accordance with the control instructions of the CPU 220, and the third I/F 250 may transmit the raw image RIMG and/or the metadata MTD to the data processing system 100.

The CPU 110 of the data processing system 100 may receive the raw image RIMG and/or the metadata MTD from the DUT 200, and receive the specification SPEC and/or the reference image REFIMG from an external device in operation S120. The raw image RIMG, the metadata MTD, the specification SPEC, and the reference image REFIMG may be stored in the memory 130 in accordance with the control instructions of the CPU 110. The specification SPEC and/or the reference image REFIMG may be stored in the memory 130 before the reception of the raw image RIMG and/or the metadata MTD.

The CPU 110 may execute the auto-tuning program 170 stored in the memory 130 and may (automatically) tune the operation parameters PARA, which will be used in the ISP 210 to process the raw image RIMG, using the raw image RIMG, the metadata MTD, and/or either of the specification SPEC and/or the reference image REFIMG, which are stored in the memory 130. The operation parameters PARA may be divided into dynamic parameters which need to be tuned to satisfy the specification SPEC and/or the reference image REFIMG, and/or static parameters which have fixed values regardless of the specification SPEC and/or the reference image REFIMG. The dynamic parameters may be grouped into a plurality of the parameter sets PS1 through PSn. The CPU 110 may tune parameters concerning a parameter set (e.g., the first parameter set PS1) selected from among the parameter sets PS1 through PSn according to the selection signal SEL input by a user, software program, desired order, and/or according to a sequential order.

The CPU 110 may tune the first representative value Prep1 of the first parameter set PS1 using the results of behavior modeling of the first parameter set PS1 in operation S130, in response to receiving the selection signal SEL indicating the first parameter set PS1. The CPU 110 may tune the parameters P1-1 through P1-i in the first parameter set PS1 based on the tuned first representative value Prep1 in operation S140. At this time, the CPU 110 may refer to the mapping table 175 which maps the first representative value Prep1 to the parameters P1-1 through P1-i in the first parameter set PS1. For instance, when the first representative value Prep1 is the third level LV3, the CPU 110 may tune the parameters P1-1 through P1-i to the values Pv3(1-1) through Pv3(1-i) stored in the mapping table 175 illustrated in FIG. 5, according to at least one example embodiment. The CPU 110 may transmit the operation parameters PARA tuned using the auto-tuning program o the DUT 200 in operation S150.

The ISP 210 of the DUT 200 may store the operation parameters PARA received from the data processing system 100 in the register 215 in accordance with the control instructions of the CPU 220 in operation S160 and may read the raw image RIMG from the memory 205 in operation S170.

The plurality of image processing blocks of the one or more pipelines in the ISP 210 may process the raw image RIMG from the memory 205 using the operation parameters PARA stored in the register 215 to generate the tuned image TIMG in operation S180. The tuned image TIMG may he output to the test system 300 in accordance with the control instructions of the CPU 220 in operation S190. The test system 300 may determine whether the tuned image TIMG output from the DUT 200 satisfies parameter values defined in the specification SPEC and may output the determination result.

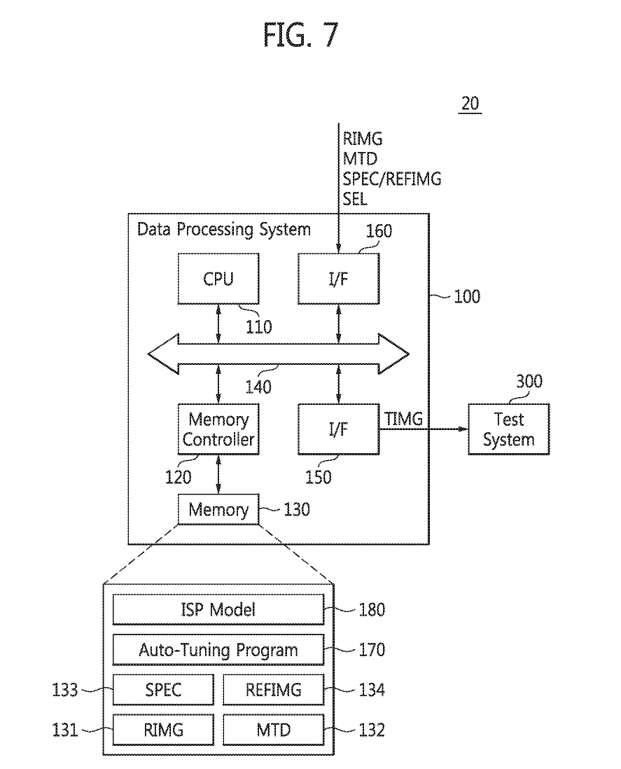

FIG. 7 is a block diagram of an auto-tuning system 20 for automatically tuning operation parameters of an ISP according to other example embodiments of the inventive concepts. Referring to FIGS. 1 and 7, the auto-tuning system 20 includes the data processing system 100 and the test system 300. Unlike the auto-tuning system 10 illustrated in FIG. 1, the auto-tuning system 20 does not include the DUT 200 formed in hardware. The auto-tuning program 170 executed by the CPU 110 in the auto-tuning system 20 may (automatically) tune parameters for an ISP model 180 modeled in software.

The ISP model 180 may be modeled by a circuit simulator and programmed using the C language, for example, or other programming languages. The ISP model 180 may be a software component which performs ISP functions modeled by the circuit simulator.

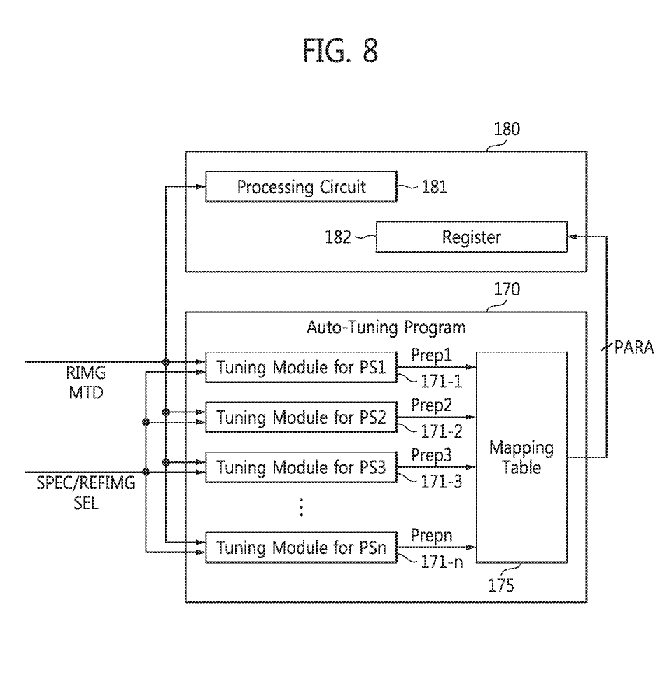

FIG. 8 is a block diagram for explaining the operation of the auto-tuning program 170 executed in the data processing system 100 illustrated in FIG. 7 and the operation of a modeled ISP, according to at least one example embodiment. Referring to FIGS. 7 and 8, the CPU 110 may load the auto-tuning program 170 and the ISP model 180 from the memory 130 to a cache memory and execute the auto-tuning program 170 and the ISP model 180 in order to (automatically) tune the operation parameters PARA of the ISP model 180.

The procedure for tuning the operation parameters PARA of the ISP model 180 using the auto-tuning program 170 may be the same as, or similar to, the procedure described with reference to FIGS. 2 through 6. The ISP model 180 is provided with the operation parameters PARA, tuned using the auto-tuning program 170, and may store the operation parameters PARA in a register 182. A processing circuit 181 of the ISP model 180 may read the raw image RIMG from the memory 130 and perform image processing on the raw image RIMG using the operation parameters PARA stored in (and/or programmed to) the register 182 to generate the tuned image TIMG. The image processing may include, for example, bad pixel correction, noise reduction, lens shading correction, color correction, gamma (or gamma curve) correction, sharpness enhancement, auto exposure correction, auto focus correction, and/or auto white balance, etc.

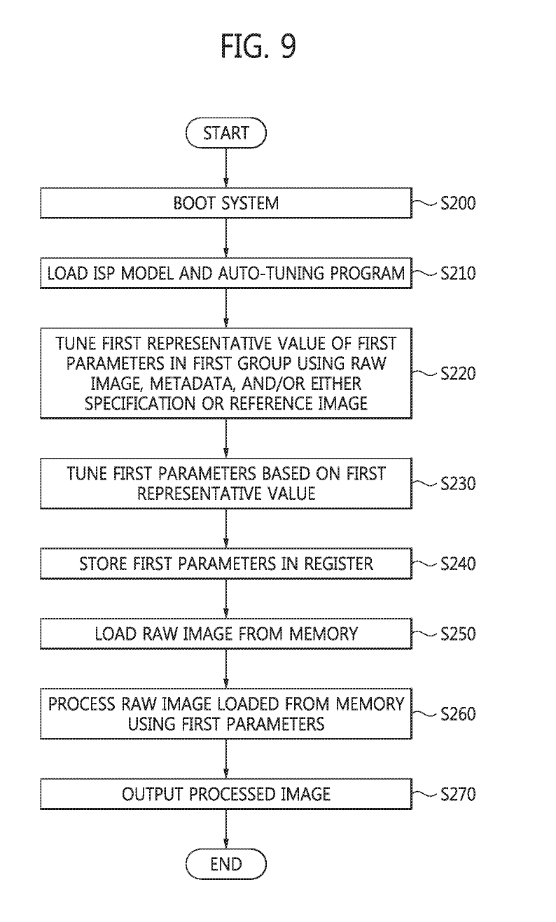

FIG. 9 is a flowchart of a method of automatically tuning the operation parameters PARA of an ISP according to other example embodiments of the inventive concepts. Referring to FIGS. 6 through 9, when the data processing system 100 is booted in operation S200, the CPU 110 may read the auto-tuning program 170 and the ISP model 180 from the memory 130 and execute the auto-tuning program 170 and the ISP model 180 in operation S210.

The auto-tuning program 170 may tune the operation parameters PARA, which will be set or programmed in the ISP model 180, using the raw image RIMG, the metadata MTD, and/or either of the specification SPEC and the reference image REFIMG, which are stored in the memory 130, in accordance with the control instructions of the CPU 110. The kinds of the operation parameters have been described above. The auto-tuning program 170 may tune the values of parameters concerning one or more parameter sets (e.g., the first parameter set PS1 as illustrated in FIG. 9, but not limited thereto) selected from among the parameter sets PS1 through PSn according to the selection signal SEL input by a user, a software program, a desired order, and/or according to the sequential order in accordance with the control instructions of the CPU 110.

In accordance with the control instructions of the CPU 110, the auto-tuning program 170 may tune the first representative value Prep1 of the first parameter set PS1 using the result of behavior modeling of the first parameter set PS1 in operation S220, and may tune the values of the parameters P1-1 through P1-i in the first parameter set PS1 based on the tuned first representative value Prep1 in operation S230. At this time, the CPU 110 may refer to the mapping table 175 which maps the first representative value Prep1 to the parameters P1-1 through P1-i in the first parameter set PS1. The ISP model 180 may receive the operation parameters PARA tuned by the auto-tuning program 170 and store the operation parameters PARA in the register 182 in operation S240.

The ISP model 180 may read the raw image RIMG from the memory 130 and perform image processing on the raw image RIMG from the memory 130 using the operation parameters PARA programmed to the register 182 to generate the tuned image TIMG in operation S260. The tuned image TIMG may be output to the test system 300 in operation S270 and/or to other external devices.

As described above, according to some example embodiments of the inventive concepts, a method of operating an auto-tuning system allows operation parameters of an ISP, which are involved in objective/subjective image quality evaluation, to be automatically tuned, thereby quickly providing the operation parameters improved and/or optimized to the change in a camera module or user's various demands and/or preferences.

The units and/or modules described herein may be implemented using hardware components, software components, or a combination thereof. For example, the hardware components may include microcontrollers, memory modules, sensors, amplifiers, band-pass filters, analog to digital converters, and processing devices, or the like. A processing device may be implemented using one or more hardware device configured to carry out and/or execute program code by performing arithmetical, logical, and input/output operations. The processing device(s) may include a processor, a controller and an arithmetic logic unit, a digital signal processor, a microcomputer, afield programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors, multi-core processors, distributed processing, or the like.

The software may include a computer program, a piece of code, an instruction, or some combination thereof, to independently or collectively instruct and/or configure the processing device to operate as desired, thereby transforming the processing device into a special purpose processor. Software and data may be embodied permanently or temporarily in any type of machine, component, physical or virtual equipment, or computer storage medium or device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of some example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

It should be understood that example embodiments described herein should be considered in a descriptive sense only and not for purposes of limitation. Descriptions of features or aspects within each device or method according to example embodiments should typically be considered as available for other similar features or aspects in other devices or methods according to example embodiments. While some example embodiments have been particularly shown and described, it will be understood by one of ordinary skill in the art that variations in form and detail may be made therein without departing from the spirit and scope of the claims.

What is claimed is:

1. A method of automatically tuning at least one operation parameter of at least one image signal processor configured to process a raw image in a data processing system including at least one processor, the method comprising:
receiving, by the at least one processor, the raw image, which will be processed by at least one image signal processor, and metadata related to generation of the raw image;
automatically tuning, by the at least one processor, a first representative value of a first parameter set using the raw image, the metadata, and at least one of a specification and a reference image, the first parameter set including a plurality of parameters grouped according to an operation parameter;
automatically tuning, by the at least one processor, each of the plurality of parameters of the first parameter set based on the first representative value that has been tuned; and
transmitting, by the at least one processor, the plurality of parameters of the first parameter set that have been tuned to the at least one image signal processor.

2. The method of claim 1, further comprising:
selectively executing, by the at least one processor, the first parameter set among a plurality of parameter sets based on a user input.

3. The method of claim 1, wherein the receiving the raw image and the metadata comprises receiving the raw image and the metadata from a device being tested, the data processing system including the at least one image signal processor.

4. The method of claim 1, wherein the automatically tuning each of the plurality of parameters of the first parameter set comprises automatically tuning each of the plurality of parameters using a mapping table which maps the first representative value to each of the plurality of parameters of the first parameter set.

5. The method of claim 1, wherein the plurality of parameters of the first parameter set includes at least one parameter related to at least one of: bad pixel correction, noise reduction, lens shading correction, color correction, gamma correction, sharpness enhancement, auto exposure correction, auto focus correction, and auto white balance.

6. The method of claim 1, wherein
the at least one image signal processor is an image signal processor modeled by a circuit simulator; and
the at least one processor executes the modeled image signal processor.

7. The method of claim 6, wherein the modeled image signal processor is configured to:
set the tuned plurality of parameters in a register of the modeled image signal processor;
generate a tuned image by processing the raw image using the plurality of parameters set in the register; and
output the tuned image.

8. A method of automatically tuning operation parameters of at least one image signal processor which processes a raw image in an auto-tuning system, the auto-tuning system including a data processing system and a device under test (DUT), the data processing system including at least one processor and the DUT including the at least one image signal processor, the method comprising:
capturing, using an image sensor included in the DUT, an image;
generating, using the image sensor, the raw image related to the captured image;
generating, using the image signal processor, metadata involved in the generation of the raw image;
automatically tuning, by the at least one processor, a first representative value of a first parameter set related to a plurality of parameters grouped in the first parameter set using the raw image, the metadata, and at least one of a specification and a reference image, the first parameter set related to an operation parameter;
automatically tuning, by the at least one processor, the plurality of parameters of the first parameter set based on the first representative value that has been tuned; and
transmitting, by he at least one processor, the plurality of parameters that have been tuned to the DUT.

9. The method of claim 8, further comprising:
receiving, by the at least one image signal processor, the plurality of parameters that have been tuned;
storing, by the at least one image signal processor, the plurality of parameters that have been received in a register of the at least one image signal processor;
reading, by the at least one image signal processor, the raw image from a memory included in the DUT;
generating, by the at least one image signal processor, a tuned image by processing the raw image output from the memory using the stored plurality of parameters; and
outputting, by the at least one image signal processor, the tuned image.

10. The method of claim 9, further comprising:
determining, by a test system, whether the tuned image output from the image signal processor satisfies a second plurality of parameters which are included in the specification and correspond to the plurality of parameters; and
outputting, by the test system, a determination result based on the determining,
wherein the auto-tuning system further includes the test system.

11. The method of claim 8, wherein at least one of the plurality of parameters are related to at least one of: had pixel correction, noise reduction, lens shading correction, color correction, gamma correction, sharpness enhancement, auto exposure correction, auto focus correction, and auto white balance.

12. The method of claim 8, further comprising:
selectively executing, by the at least one processor, the first parameter set among a plurality of parameter sets based on a user input.

13. The method of claim 8, wherein the automatically tuning the plurality of parameters includes automatically tuning the first parameters using a mapping table which maps the first representative value to the plurality of parameters.

14. A method of tuning operation parameters for at least one image signal processor, the method comprising:
loading, by at least one processor, an image signal processor model into a memory;
tuning, by the at least one processor, at least one operation parameter associated with the loaded image signal processor using at least a raw image and metadata related to the raw image;
storing, by the at least one processor, the tuned at least one operation parameter into the memory;
processing, by the at least one processor, the raw image using the image signal processor model in accordance with the tuned at least one operation parameter; and
outputting, by the at least one processor, the processed image to an external device for testing.

15. The method of claim 14, wherein the tuning includes tuning the at least one operation parameter using an image specification or a reference image.

16. The method of claim 14, wherein the at least one operation parameter is a parameter associated with bad pixel correction, noise reduction, lens shading correction, color correction, gamma correction, sharpness enhancement, auto exposure correction, auto focus correction, and auto white balance.

17. The method of claim 14, wherein the image signal processor model includes at least one image signal processing pipeline, the pipeline including a plurality of image processing blocks.

18. The method of claim 17, wherein the at least one operation parameter includes a plurality of operation parameters, the plurality of operation parameters grouped into at least a dynamic operation parameter group and a static dynamic group.

19. The method of claim 18, wherein
the dynamic operation parameter group includes operation parameters that exert a direct influence on an output of the image processing blocks; and
the static operation parameter group includes the operation parameters of the plurality of operation parameters not included in the dynamic operation parameter group.

20. The method of claim 14, wherein the tuning includes:
receiving at least one parameter value associated with the at least one operation parameter;
receiving a selection signal indicating an operation parameter set to be tuned; and
tuning the selected operation parameter set using the received at least one parameter value.
